(19) United States
(12) Patent Application Publication
(10) Pub. No.: US 2017/0110063 A1
(43) Pub. Date: Apr. 20, 2017

(54) LIQUID CRYSTAL DISPLAY DEVICE, TELEVISION RECEIVER AND METHOD OF CONTROLLING BACKLIGHT OF LIQUID CRYSTAL DISPLAY DEVICE

(71) Applicants: Kabushiki Kaisha Toshiba, Tokyo (JP); Toshiba Lifestyle Products & Services Corporation, Tokyo (JP)

(72) Inventors: Takayuki Arai, Hamura Tokyo (JP); Toshio Obayashi, Ome Tokyo (JP); Masaki Tsuchida, Hamura Tokyo (JP); Ko Sato, Akishima Tokyo (JP)

(21) Appl. No.: 15/158,906

(22) Filed: May 19, 2016

(30) Foreign Application Priority Data
Oct. 14, 2015 (JP) 2015-202893

(51) Int. Cl. G09G 3/34; H04N 5/57; G09G 3/36

(52) U.S. Cl. CPC G09G 3/3406; G09G 3/36; H04N 5/57; G09G 2320/064; G09G 2330/021; G09G 2320/0646; G09G 2360/16

(57) ABSTRACT

According to one embodiment, a liquid crystal display device includes a liquid crystal display panel, a backlight, a liquid crystal driving unit and a backlight driving unit. In each area, when the brightness level calculated based on the video signal is greater than or equal to a first threshold level, the backlight driving unit fixes a driving current supplied to the light emitting elements in one frame period and controls a lighting time according to the calculated brightness level. In each area, when the brightness level is less than the first threshold level, the backlight driving unit fixes the lighting time of the light emitting elements in one frame period and controls the driving current according to the calculated brightness level.

### CROSS-REFERENCE TO RELATED APPLICATIONS

This application is based upon and claims the benefit of priority from Japanese Patent Application No. 2015-202893, filed Oct. 14, 2015, the entire contents of which are incorporated herein by reference.

### FIELD

Embodiments described herein relate generally to a liquid crystal display device, a television receiver and a method of controlling a backlight of the liquid crystal display device.

### BACKGROUND

Recently, high-dynamic-range technology characterized by high brightness and contrast has been attracting attention in a liquid crystal display device used for a television receiver. In order to achieve high-dynamic-range display, backlight control technology is especially significant. At present, light emitting diodes (LEDs) are often used in the backlight controlling method. There is a method of dividing a screen vertically and horizontally and adjusting brightness per area. Methods of adjusting brightness of LEDs include a method of controlling a lighting time of LEDs in one frame period in accordance with average brightness of video data in a corresponding area, a method of controlling a driving current of LEDs, etc.

It should be noted that, when adjusting brightness of a backlight of a liquid crystal display device by using LEDs, the method of controlling a lighting time of LEDs in one frame period has a problem that stable brightness adjustment becomes difficult as the lighting time becomes short. The method of controlling a driving current of LEDs also has a problem that chromatic variation becomes large if a current level varies largely.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a structure of a television receiver equipped with a liquid crystal display device of embodiments.

FIG. 2 is a block diagram showing a structure of a liquid crystal display device of a first embodiment.

FIG. 3 is a flowchart specifically showing a driving current determination process by a driving current and lighting time determination unit shown in FIG. 2.

FIG. 4 is a flowchart specifically showing a lighting time determination process by the driving current and lighting time determination unit shown in FIG. 2.

FIG. 5 is an illustration showing a method of controlling brightness by a backlight driving unit of the first embodiment.

FIG. 6 is an illustration showing an overview of driving current control and lighting time control by the backlight driving unit of the first embodiment.

FIG. 7 is a flowchart specifically showing a driving current determination process in a liquid crystal display device of a second embodiment.

FIG. 8 is a flowchart specifically showing a lighting time determination process in the liquid crystal display device of the second embodiment.

FIG. 9 is an illustration showing an overview of driving current control and lighting time control by a backlight driving unit of the second embodiment.

FIG. 10 is a block diagram showing a structure of a liquid crystal display device of a third embodiment.

FIG. 11 is a flowchart specifically showing a driving current determination process by a driving current and lighting time determination unit shown in FIG. 10.

FIG. 12 is a flowchart specifically showing a lighting time determination process by the driving current and lighting time determination unit shown in FIG. 10.

### DETAILED DESCRIPTION

Various embodiments will be described hereinafter with reference to the accompanying drawings. In general, according to one embodiment, a liquid crystal display device includes a liquid crystal display panel, a backlight, a liquid crystal driving unit and a backlight driving unit. The liquid crystal display panel includes a display screen on which liquid crystal cells are arranged horizontally and vertically. The backlight provides on a back of the liquid crystal display panel and configured to control brightness by dividing the display screen into areas horizontally and vertically and causing light emitting elements arranged in each area to emit light. The liquid crystal driving unit is configured to input a video signal, to supply each cell of the liquid crystal display panel with a driving signal corresponding to each pixel of the video signal, and to control transmittance of each cell. The backlight driving unit is configured to calculate a brightness level for each area of the backlight based on the video signal, and to drive the light emitting elements to be at the calculated brightness level. In each area, when the brightness level calculated based on the video signal is greater than or equal to a first threshold level. The backlight driving unit fixes a driving current supplied to the light emitting elements in one frame period and controls a lighting time according to the calculated brightness level. In each area, when the brightness level is less than the first threshold level, the backlight driving unit fixes the lighting time of the light emitting elements in one frame period and controls the driving current according to the calculated brightness level.

Embodiments will be described hereinafter with reference to the accompanying drawings.

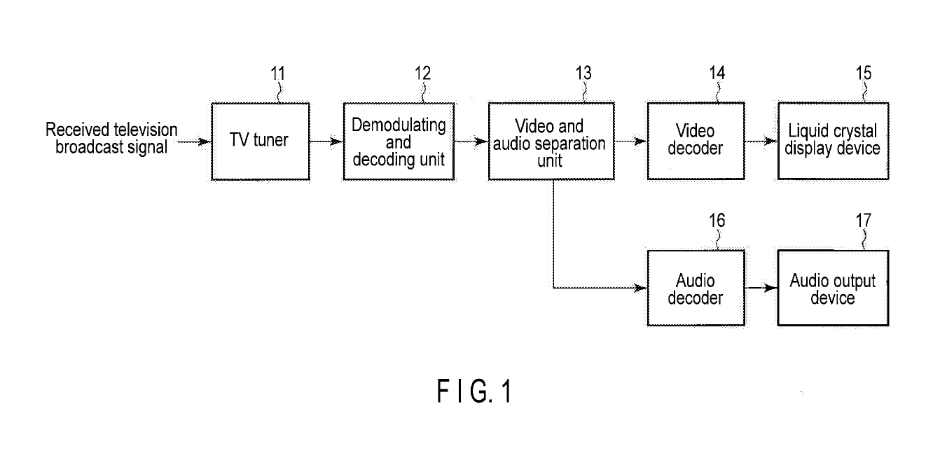

FIG. 1 is a block diagram showing a structure of a television receiver equipped with a liquid crystal display device of the embodiments. In FIG. 1, a TV tuner 11 inputs digital broadcast signals received from an antenna (not shown) and selects a broadcast signal of a specified channel. The selected broadcast signal is transmitted to a demodulating and decoding unit 12. The demodulating and decoding unit 12 executes demodulating and error correction decoding for the input broadcast signal and converts the signal into a transport stream (TS) signal. The TS signal is transmitted to a video and audio separation unit 13. The video and audio separation unit 13 separates the input TS signal into a video stream and an audio stream. The separated video signal is converted from the video stream to video data of a predetermined resolution by a video decoder 14, transmitted to a liquid crystal display device 15 and displayed on a liquid crystal display panel as video. The separated audio signal is converted from the audio stream to audio data of a specified mode by an audio decoder 16, transmitted to an audio output device 17 and reproduced by a speaker.

Liquid crystal display devices of first to third embodiments applied to the above television receiver are hereinafter described.

### First Embodiment

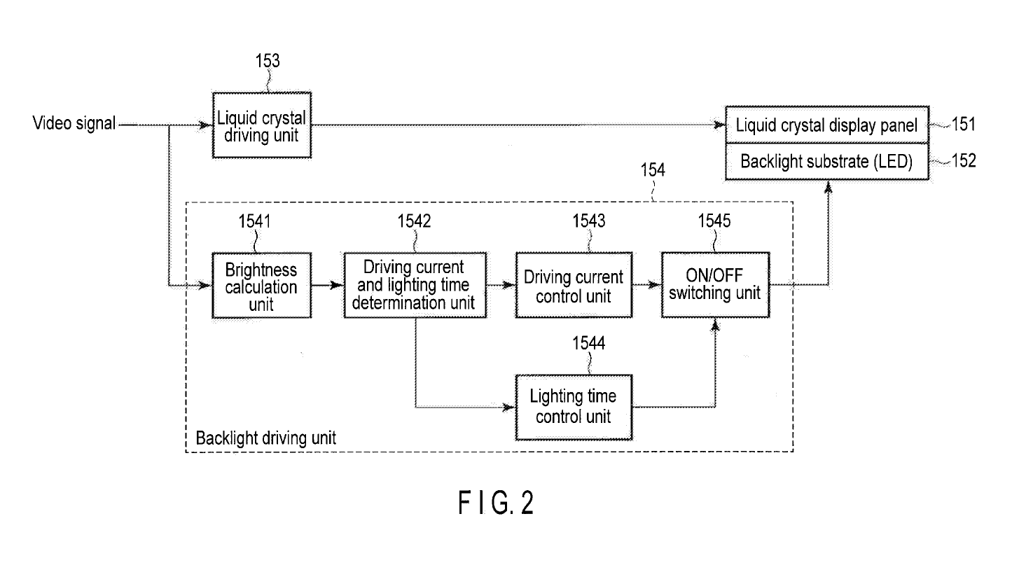

FIG. 2 is a block diagram showing a specific structure of a liquid crystal display device 15 of the first embodiment. In FIG. 2, 151 is a liquid crystal display panel comprising a liquid crystal layer sandwiched between a pair of substrates. A predetermined number of liquid crystal cells are arranged vertically and horizontally in a display screen of the liquid crystal display panel 151. 152 is a backlight substrate provided on the back of the liquid crystal display panel 151 and configured to adjust brightness by dividing the display screen into areas horizontally and vertically and arranging LEDs in each area.

The input video data is transmitted to a liquid crystal driving unit 153 and a backlight driving unit 154. The liquid crystal driving unit 153 supplies each cell of the liquid crystal display panel 151 with a driving signal corresponding to each pixel of the video data and controls transmittance of each cell. The backlight driving unit 154 calculates a brightness level of each area based on the video data and drives LEDs arranged in each area of the backlight substrate 152 to be at the calculated brightness level.

In the backlight driving unit 154, a brightness calculation unit 1541 calculates a brightness level of the backlight of each area based on the input video data. A driving current and lighting time determination unit 1542 determines a driving current and a lighting time of LEDs in one frame period in each area based on the brightness level calculated per area. A driving current control unit 1543 controls a driving current for LEDs in each area based on a level determined by the determination unit 1542. A lighting time control unit 1544 transmits, to an on/off switching unit 1545 provided subsequently to the driving current control unit 1543, an on/off switching signal of the driving current to be supplied to LEDs in each area based on the lighting time in one frame period determined in the determination unit 1542. In this manner, the driving current and the lighting time of LEDs of each area are controlled to achieve the calculated brightness level.

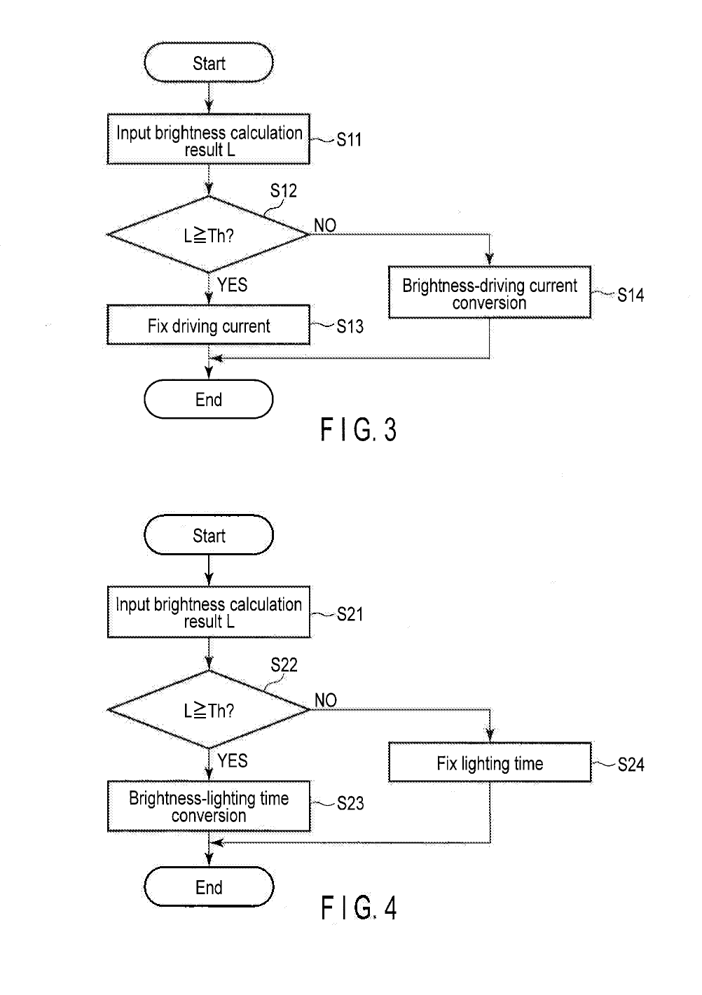

FIG. 3 is a flowchart specifically showing a driving current determination process by the driving current and lighting time determination unit 1542 shown in FIG. 2. In FIG. 3, if the brightness calculation unit 1541 obtains a brightness calculation result L of each area (step S11), the brightness calculation result L is compared with a threshold level Th to determine whether the brightness calculation result L is classified as low brightness (step S12). In each area, if the brightness calculation result L is greater than or equal to the threshold level Th (Yes), the driving current of the LEDs is fixed to, for example, a maximum level (step S13). If the brightness calculation result L is less than the threshold level Th (No), the driving current level is increased or decreased in accordance with preliminarily-obtained brightness-current characteristics (brightness-current conversion) (step S14). For example, a look-up table (LUT) is used for the brightness-current conversion.

FIG. 4 is a flowchart specifically showing a lighting time determination process by the driving current and lighting time determination unit 1542 shown in FIG. 2. In FIG. 4, if the brightness calculation unit 1541 obtains a brightness calculation result L of each area (step S21), the brightness calculation result L is compared with a threshold level Th to determine whether the brightness calculation result L is classified as low brightness (step S22). In each area, if the brightness calculation result L is greater than or equal to the threshold level Th (Yes), the lighting time of LEDs in one frame period is increased or decreased in accordance with preliminarily-obtained brightness-lighting time characteristics (brightness-lighting time conversion) (step S23). If the brightness calculation result L is less than the threshold level Th (No), the lighting time is fixed to, for example, a minimum level (step S24).

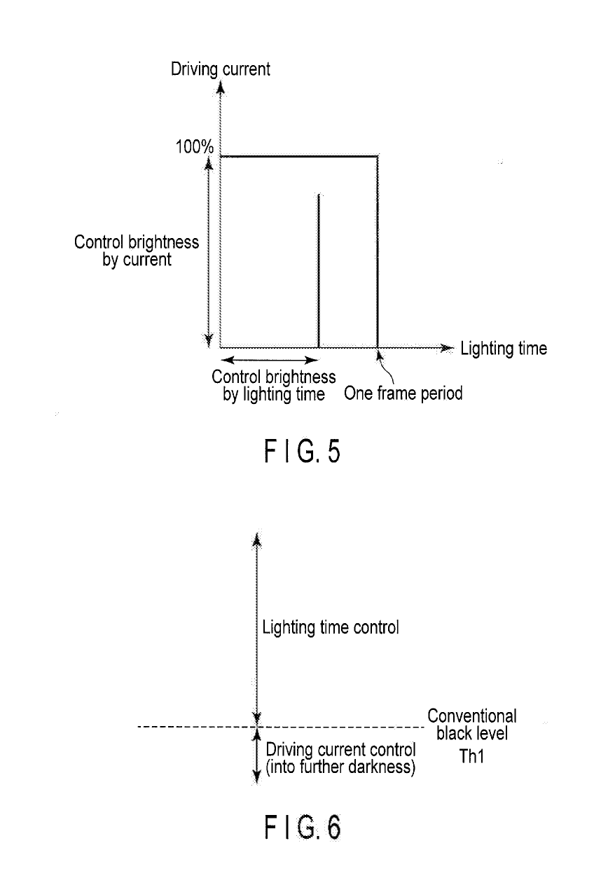

That is, as shown in FIG. 5, a hybrid control method using both a method of controlling brightness by the driving current and a method of controlling brightness by the lighting time is adopted in the present embodiment. On the assumption that both the driving current and the lighting time are proportional to the brightness of LEDs, a region surrounded by a square in FIG. 5 represents brightness in one frame period. As shown in FIG. 6, lighting time control (driving current fixed) is selected in medium- and high-brightness areas (areas of a brightness level greater than or equal to the threshold level Th), and driving current control (lighting time fixed) is selected in a low-brightness area (area of a brightness level less than the threshold level Th). When adjusting the brightness of the backlight of the liquid crystal display device by using LEDs, the method of controlling the lighting time of LEDs in one frame period has a problem that stable brightness adjustment becomes difficult as the lighting time becomes short. In order to solve the problem, the lighting time is fixed to the minimum lighting time required for stable light emission in the low-brightness area, and the lighting time control is limited to the medium- and high-brightness areas. Therefore, the brightness can be stably adjusted. The method of controlling the driving current of LEDs also has a problem that chromaticity varies according to variation in current. In order to solve the problem, a current level is fixed in the medium- and high-brightness areas in which chromatic variation is easily detected, and the current control is limited to the low-brightness area. Therefore, subjective influence of chromatic variation can be reduced. In this manner, chromatic variation can be reduced by executing the lighting time control in the medium- and high-brightness areas, and a dynamic range of brightness can be expanded by decreasing the brightness in the dark area.

Therefore, according to the liquid crystal display device of the present embodiment, chromatic variation can be reduced in the medium- and high-brightness areas and stable brightness adjustment can be realized to the low-brightness area when adjusting the brightness of the backlight of the liquid crystal display device by using LEDs, which can expand the dynamic range of brightness.

### Second Embodiment

In the second embodiment, brightness can be adjusted more smoothly by setting two threshold levels to be compared with a brightness level. Since the specific structure of a liquid crystal display device 15 of the present embodiment is substantially the same as in the first embodiment shown in FIG. 2, the description thereof is omitted.

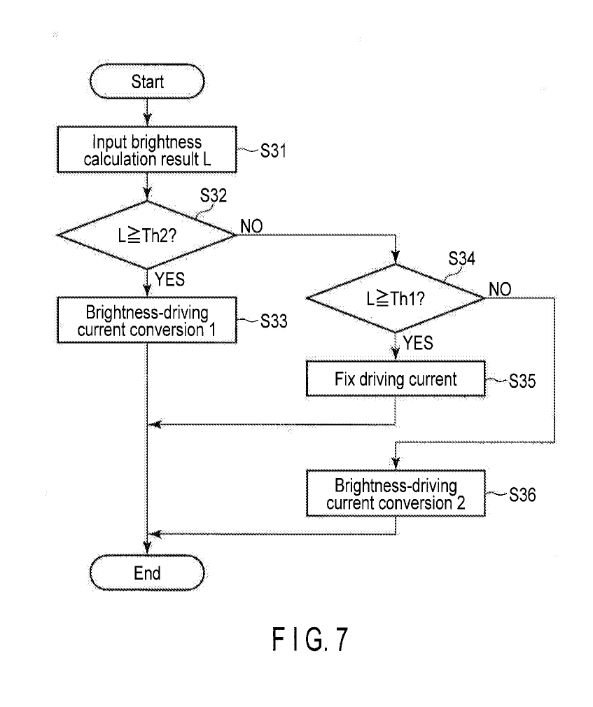

FIG. 7 is a flowchart specifically showing a driving current determination process by a driving current and lighting time determination unit 1542 in the second embodiment. In FIG. 7, if a brightness calculation unit 1541 obtains a brightness calculation result L of each area (step S31), the brightness calculation result L is compared with a second threshold level Th2 which is greater than a first threshold level Th1 (step S32). In each area, if the brightness calculation result L is greater than or equal to the second threshold level Th2 (Yes), a driving current level is increased or decreased in accordance with preliminarily-obtained first brightness-current characteristics (first brightness-current conversion) (step S33). If the brightness calculation result L is less than the second threshold level Th2 (No), the brightness calculation result L is compared with the first threshold level Th1 (step S34). In each area, if the brightness calculation result L is greater than or equal to the first threshold level Th1 (Yes), the driving current level of LEDs is fixed to, for example, a maximum level (step S35). If the brightness calculation result L is less than the first threshold level Th1 (No), the driving current level is increased or decreased in accordance with preliminarily-obtained second brightness-current characteristics (second brightness-current conversion) (step S36).

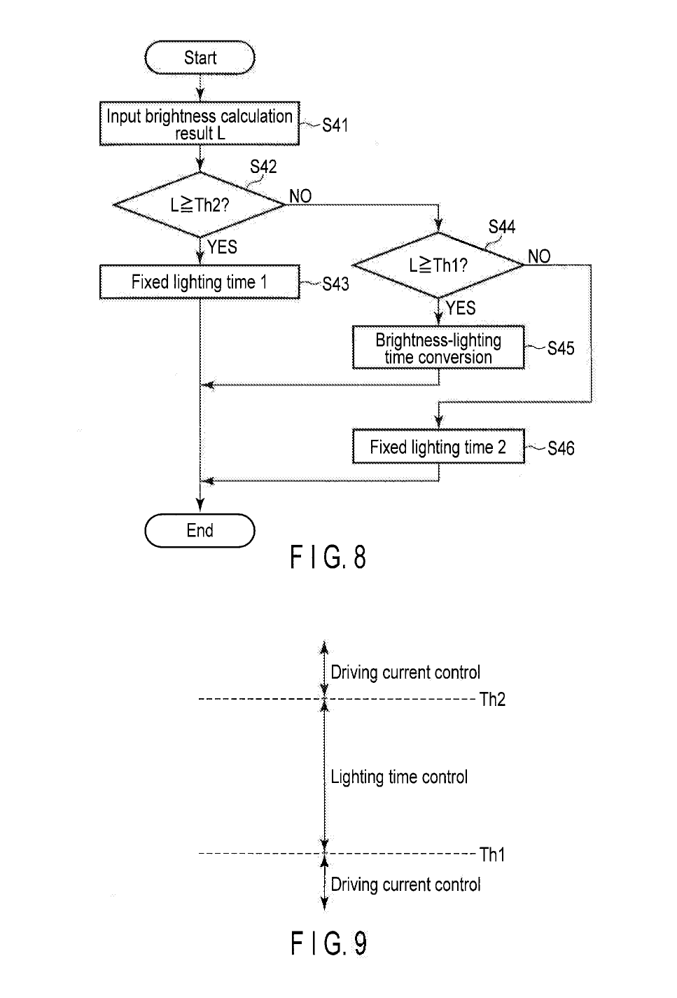

FIG. 8 is a flowchart specifically showing a lighting time determination process by the driving current and lighting time determination unit 1542 in the second embodiment. In FIG. 8, if the brightness calculation unit 1541 obtains a brightness calculation result L of each area (step S41), the brightness calculation result L is compared with a second threshold level Th2 which is greater than a first threshold level Th1 (step S42). In each area, if the brightness calculation result L is greater than or equal to the second threshold level Th2 (Yes), a lighting time is fixed to, for example, a maximum level (first fixed lighting time) (step S43). If the brightness calculation result L is less than the second threshold level Th2 (No), the brightness calculation result L is compared with the first threshold level Th1 (step S44). In each area, if the brightness calculation result L is greater than or equal to the first threshold level Th1 (Yes), the lighting time of LEDs in one frame period is increased or decreased in accordance with preliminarily-obtained brightness-lighting time characteristics (brightness-lighting time conversion) (step S45). If the brightness calculation result L is less than the first threshold level Th1 (No), the lighting time is fixed to, for example, a minimum level (second fixed lighting time) (step S46).

That is, in the present embodiment, as shown in FIG. 9, the lighting time is fixed to the maximum level and the driving current control is selected in the high-brightness area (area of a brightness level greater than or equal to the second threshold level Th2), the driving current is fixed and the lighting time control is selected in the medium-brightness area (area of a brightness level less than the second threshold level but not less than the first threshold level) in which chromatic variation is easily detected, and the lighting time is fixed to the minimum level for stable light emission and the driving current control is selected in the low-brightness area (area of a brightness level less than the first threshold level Th). In this case, the driving current control is adopted in the high- and low-brightness areas. Therefore, subjective influence of chromatic variation can be reduced in each area. In addition, since the lighting time control is executed in the medium-brightness area, the brightness can be stably adjusted.

Therefore, according to the liquid crystal display device of the present embodiment, chromatic variation can be reduced and stable brightness adjustment can be realized from low brightness to high brightness when adjusting the brightness of the backlight of the liquid crystal display device by using LEDs, which can expand the dynamic range of the brightness.

### Third Embodiment

The third embodiment is characterized in that brightness of the backlight of the entire screen is calculated in addition to the process of the first embodiment shown in FIG. 2, power consumption of the backlight is calculated based on the calculated brightness, and the driving current control and the lighting time control are arbitrarily switched on the condition that the power consumption is less than a specified power source capacity.

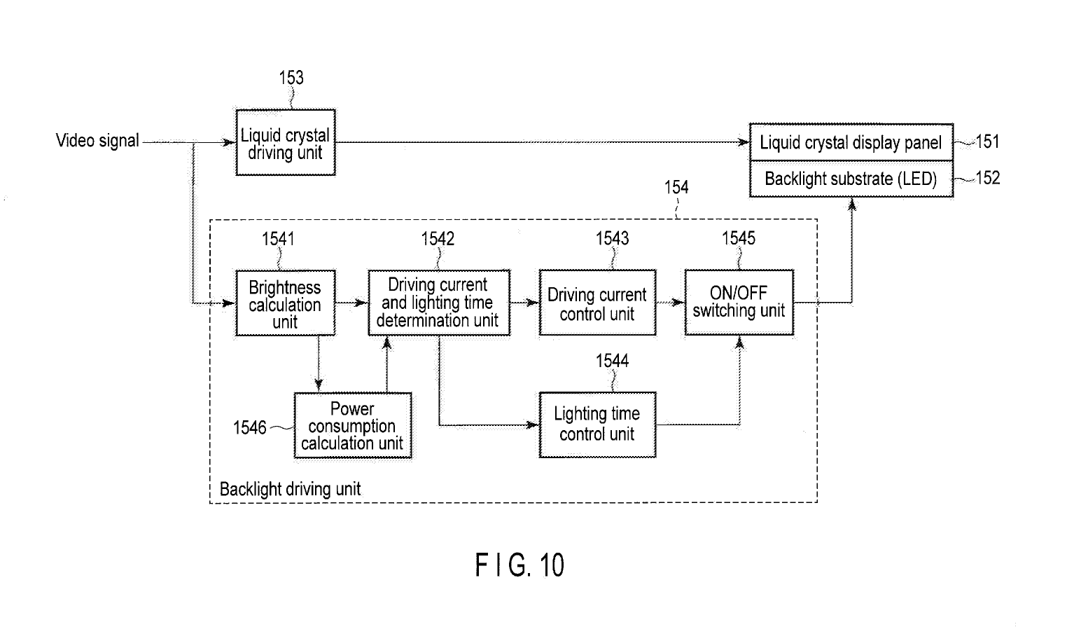

FIG. 10 is a block diagram showing a specific structure of a liquid crystal display device 15 of the third embodiment. In FIG. 10, the same components as FIG. 2 are represented by the same reference numbers and their overlapping description is omitted.

In a backlight driving unit 154 shown in FIG. 10, a power consumption calculation unit 1546 calculates brightness of the entire screen by inputting brightness levels of respective areas calculated in a brightness calculation unit 1541, and calculates power consumption of the backlight based on the calculation result. A driving current and lighting time determination unit 1542 determines a driving current and a lighting time of LEDs in one frame period in each area based on the brightness level calculated for each area and the backlight power consumption obtained by the power consumption calculation unit 1546. More specifically, if the calculated brightness level is greater than or equal to a threshold level and the power consumption is less than the specified power source capacity, the driving current is fixed and the lighting time is controlled based on the first brightness-lighting time characteristics. If the calculated brightness level is less than the threshold level, the lighting time is fixed to the second time and the driving current is controlled based on the second brightness-driving current characteristics.

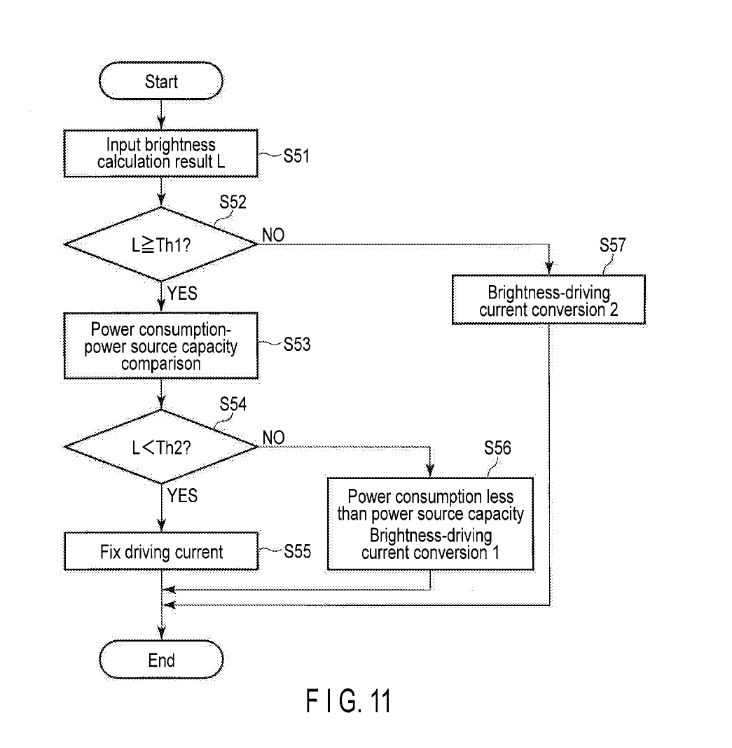

FIG. 11 is a flowchart specifically showing a driving current determination process by the driving current and lighting time determination unit 1542. In FIG. 11, if the brightness calculation unit 1541 obtains a brightness calculation result L of each area (step S51), the brightness calculation result L is compared with a first threshold level Th1 to determine whether the brightness calculation result L is classified as low brightness (step S52).

In each area, if the brightness calculation result L is greater than or equal to the first threshold level Th1 (Yes), the power consumption based on the brightness of the entire screen calculated by the power consumption calculation unit 1546 is compared with the specified power source capacity (step S53). At this time, whether L is less than a second threshold level Th2 which is greater than the first threshold level Th1 is determined (step S54). If L is less than Th2 (No), the driving current of LEDs is fixed (step S55). If the power consumption is less than the power source capacity and L is greater than or equal to the second threshold level Th2 (Yes), the driving current level of LEDs is increased or decreased in accordance with the preliminarily-obtained first brightness-current characteristics (step S56).

In step S52, if L is less than the first threshold level Th1 (No), the driving current level is increased or decreased in accordance with the preliminarily-obtained second brightness-current characteristics (step S57).

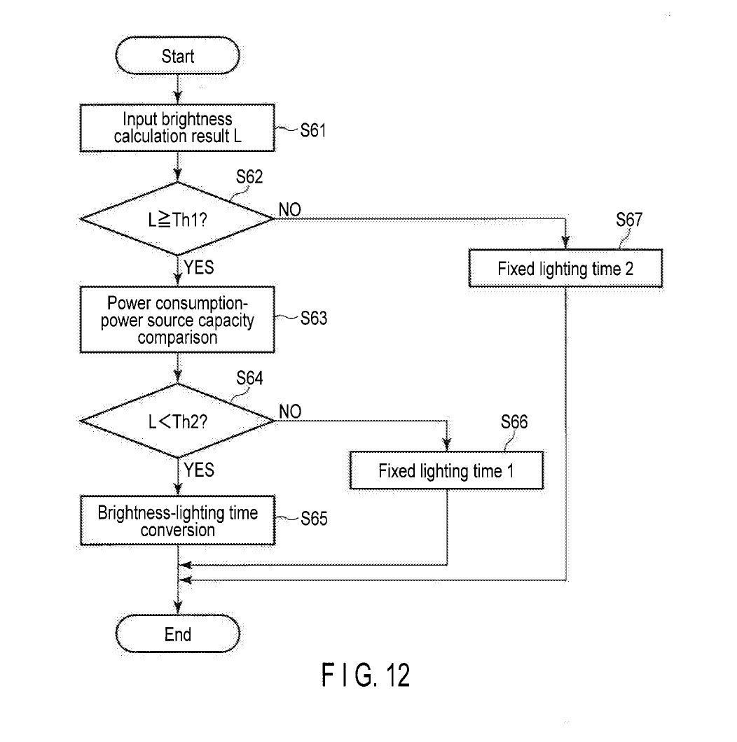

FIG. 12 is a flowchart specifically showing a lighting time determination process by the driving current and lighting time determination unit 1542. In FIG. 12, if the brightness calculation unit 1541 obtains a brightness calculation result L of each area (step S61), the brightness calculation result L is compared with the first threshold level Th1 to determine whether the brightness calculation result L is classified as low brightness (step S62).

In each area, if the brightness calculation result L is greater than or equal to the first threshold level Th1 (Yes), the power consumption based on the brightness of the entire screen calculated by the power consumption calculation unit 1546 is compared with a capacity of the power source for driving LEDs (step S63). At this time, whether L is less than a second threshold level Th2 which is greater than the first threshold level Th1 is determined (step S63). If L is less than Th2 (Yes), the lighting time is increased or decreased in accordance with the preliminarily-obtained brightness-lighting time characteristics (step S64). If L is greater than or equal to the second threshold level Th2 (Yes), the lighting time in one frame period is fixed to the first time (step S66).

In step S62, if L is less than the first threshold level Th1 (No), the lighting time is fixed to the second time (step S67).

In FIG. 11 and FIG. 12, the driving current is increased if L is greater than or equal to Th2 and the power consumption is less than the power source capacity. However, there is no problem if the lighting time corresponding to L=Th2 is preliminarily set to be less than the maximum and the lighting time is further increased when L is greater than or equal to Th2 and the power consumption is less than the power source capacity.

Therefore, according to the liquid crystal display device of the present embodiment, chromatic variation can be reduced in the medium- and high-brightness areas, the dynamic range of brightness can be expanded and the brightness of the backlight can be stably adjusted by the same process as the first embodiment. In addition, if high-brightness display is executed when the power consumption is less than the power source capacity, higher brightness display can be realized by increasing the driving current. In this manner, the brightness of the backlight can be stably adjusted from low brightness to high brightness while realizing higher brightness display within the range of the power source capacity.

In each embodiment, how to adjust the current and the lighting time after calculating the brightness level of each area is not limited to the described example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a liquid crystal display panel comprising a display screen comprising liquid crystal cells arranged horizontally and vertically;
a backlight on a back of the liquid crystal display panel and configured to control brightness by dividing the display screen into areas horizontally and vertically and causing light emitting elements arranged in each area to emit light;
a liquid crystal driver configured to input a video signal, to supply each cell of the liquid crystal display panel with a driving signal corresponding to each pixel of the video signal, and to control transmittance of each cell; and
a backlight driver configured to calculate a brightness level for each area of the backlight based on the video signal, and to drive the light emitting elements to be at the calculated brightness level, wherein
in each area, when the brightness level calculated based on the video signal is greater than or equal to a first threshold level, the backlight driver fixes a driving current supplied to the light emitting elements in one frame period and controls a lighting time according to the calculated brightness level, and
in each area, when the brightness level is less than the first threshold level, the backlight driver fixes the lighting time of the light emitting elements in one frame period and controls the driving current according to the calculated brightness level.

2. The liquid crystal display device of claim 1, wherein
in each area, when the brightness level calculated based on the video signal is greater than or equal to a second threshold level which is greater than the first threshold level, the backlight driver fixes the lighting time of the light emitting elements in one period and controls the driving current according to the calculated brightness level.

3. The liquid crystal display device of claim 1, wherein
the backlight driver calculates power consumption of all the areas based on the brightness levels calculated for the respective areas, and
in each area, when the power consumption is less than a specified power source capacity and the brightness level calculated based on the video signal is greater than or equal to a second threshold level which is greater than the first threshold level, the backlight driver fixes the lighting time in one frame period and controls the driving current according to the calculated brightness level.

4. A television receiver using a liquid crystal display device, the liquid crystal display device comprising:
a liquid crystal display panel comprising a display screen comprising liquid crystal cells arranged horizontally and vertically;
a backlight on a back of the liquid crystal display panel and configured to control brightness by dividing the display screen into areas horizontally and vertically and causing light emitting elements arranged in each area to emit light;
a liquid crystal driver configured to input a video signal of a received television program, to supply each cell of the liquid crystal display panel with a driving signal corresponding to each pixel of the video signal, and to control transmittance of each cell; and
a backlight driver configured to calculate a brightness level for each area of the backlight based on the video signal, and to drive the light emitting elements to be at the calculated brightness level, wherein
in each area, when the brightness level calculated based on the video signal is greater than or equal to a first threshold level, the backlight driver fixes a driving current supplied to the light emitting elements in one frame period and controls a lighting time according to the calculated brightness level, and
in each area, when the brightness level is less than the first threshold level, the backlight driver fixes the lighting time of the light emitting elements in one frame period and controls the driving current according to the calculated brightness level.

5. The television receiver of claim 4, wherein
in each area, when the brightness level calculated based on the video signal is greater than or equal to a second threshold level which is greater than the first threshold level, the backlight driver fixes the lighting time of the light emitting elements in one period and controls the driving current according to the calculated brightness level.

6. The television receiver of claim 4, wherein
the backlight driver calculates power consumption of all the areas based on the brightness levels calculated for the respective areas, and
in each area, when the power consumption is less than a specified power source capacity and the brightness level calculated based on the video signal is greater than or equal to a second threshold level which is greater than the first threshold level, the backlight driver fixes the lighting time in one frame period and controls the driving current according to the calculated brightness level.

7. A method of controlling a backlight of a liquid crystal display device, the liquid crystal display device comprising: a liquid crystal display panel comprising a display screen comprising liquid crystal cells arranged horizontally and vertically; and the backlight on a back of the liquid crystal display panel, and configured to control brightness by dividing the display screen into areas horizontally and vertically and causing light emitting elements arranged in each area to emit light, the liquid crystal display device configured to input a video signal, to supply each cell of the liquid crystal display panel with a driving signal corresponding to each pixel of the video signal, and to control transmittance of each cell, the method comprising:
calculating a brightness level for each area of the backlight based on the video signal;
driving the light emitting elements to be at the calculated brightness level;
in each area, when the brightness level calculated based on the video signal is greater than or equal to a first threshold level, fixing a driving current supplied to the light emitting elements in one frame period and controlling a lighting time according to the calculated brightness level; and
in each area, when the brightness level is less than the first threshold level, fixing the lighting time of the light emitting elements in one frame period and controlling the driving current according to the calculated brightness level.

8. The method of claim 7, further comprising:
in each area, when the brightness level calculated based on the video signal is greater than or equal to a second threshold level which is greater than the first threshold level, fixing the lighting time of the light emitting elements in one period and controlling the driving current according to the calculated brightness level.

9. The method of claim 7, further comprising:
calculating power consumption of all the areas based on the brightness levels calculated for the respective areas; and
in each area, when the power consumption is less than a specified power source capacity and the brightness level calculated based on the video signal is greater than or equal to a second threshold level which is greater than the first threshold level, fixing the lighting time in one frame period and controlling the driving current according to the calculated brightness level.
